(19) United States
(12) Patent Application Publication
(10) Pub. No.: US 2025/0369875 A1
(43) Pub. Date: Dec. 4, 2025

(54) OPTICAL ADAPTER MODULE AND SPECTROMETRIC SYSTEM

(71) Applicant: Endress+Hauser Optical Analysis, Inc., Ann Arbor, MI (US)

(72) Inventors: Jürgen Dessecker, Wittlingen (DE); Patrick Ehlers, Mölnlycke (SE); Oliver Link, Gundelfingen (DE); Joseph B. Slater, Dexter, MI (US); Sebastian Stöcklin, Malterdingen (DE); Guido Törber, Freiburg (DE); Marc Winter, Gelnhausen (DE)

(21) Appl. No.: 19/220,798

(22) Filed: May 28, 2025

(30) Foreign Application Priority Data
May 29, 2024 (DE) 10 2024 115 061.0

(51) Int. Cl. G01N 21/31

(52) U.S. Cl. CPC G01N 21/31; G01N 2201/08; G01N 2201/127

(57) ABSTRACT

An electro-optical adapter module includes a housing; at least one input interface with a connector on the housing, wherein the input interface is designed to be connected to a probe via a cable; an output interface with a connector on the housing, wherein the output interface is designed to be connected to a spectrometric base module; with an, for example, bidirectional, electrical connection from the input interface to the output interface; a first optical connection from the input interface to the output interface for optical input signals, for example, measurement signals; and a second optical connection from the output interface to the input interface for optical output signals, for example excitation signals.

### CROSS-REFERENCE TO RELATED APPLICATION

The present application is related to and claims the priority benefit of German Patent Application No. 10 2024 115 061.0, filed on May 29, 2025, the entire contents of which are incorporated herein by reference.

### TECHNICAL FIELD

The present disclosure relates to an optical adapter module and spectrometric system comprising such.

### BACKGROUND

A generic spectrometric system is marketed by the applicant—for example, under the name “Rxn5 analyzer.” This is a laser-based Raman analyzer designed for applications in the petrochemical and other process markets.

A spectrometric system is used to determine the composition of gas mixtures, liquids, or solids without the need for valves, furnaces, columns, or carrier gases. The system consists of the actual spectrometer with a light source, usually a laser, a diffractive or dispersive element, and a detector, wherein the spectrometer is connected to the process, i.e., the medium to be measured, via one or more probes that are connected to the spectrometer via an optical fiber. Instead of a diffractive or dispersive element, an interferometer can be used. For example, up to four independent probes can be connected, the probes working simultaneously. Variants with sequential measurement or both sequential and simultaneous measurement are also known.

It is possible to measure gas mixtures with multiple components. Example gases that can be analyzed are: H₂, N₂, O₂, CO, CO₂, H₂S, CH₄, C₂H₄, C₂H, Cl₂, F₂, HF, BF₃, SO₂, and NH₃. A mixture of solids or liquids is also possible.

Different probes are used for each gas or medium. When operating spectrometers with probes, the correct combination of connector and optical fiber must be selected, since only probes with the appropriate connector and fiber optic cable combination can be connected.

### SUMMARY

The present disclosure is based upon the object of providing a universal spectrometric system.

The object is achieved by an electro-optical adapter module, comprising a housing; at least one input interface with a connector on the housing, wherein the input interface is designed to be connected to a probe via a cable; an output interface with a connector on the housing, wherein the output interface is designed to be connected to a spectrometric base module; with a, for example, bidirectional, electrical connection from the input interface to the output interface; a first optical connection from the input interface to the output interface for optical input signals, for example, measurement signals; and a second optical connection from the output interface to the input interface for optical output signals, for example, excitation signals.

At least one embodiment provides that the electro-optical adapter module comprises a first input interface with a connector on the housing, wherein the input interface is designed to be connected to a first probe via a first cable; at least one second input interface with a connector on the housing, wherein the input interface is designed to be connected to a second probe via a second cable; wherein the first optical connection conducts input signals from the first input interface and the second input interface to the output interface; an optical selection circuit, for example, an optical demultiplexer or an optical switch, which, in the second optical connection, distributes output signals from the output interface to the input interface.

When reference is made below to “the” input interface, this always also refers to the embodiment with more than one input interface, for example, as described in the embodiment with a first input interface and a second input interface. Embodiments with more input interfaces, e.g., four, are possible.

At least one embodiment provides that the first optical connection comprises mirrors, optical switches, optical shunts, and/or beam splitters.

At least one embodiment provides that the connectors of the input interface and the output interface be designed differently.

At least one embodiment provides that a transfer fiber connect the input interface with the output interface and lead through the optical input signals and optical output signals.

At least one embodiment provides that the electro-optical adapter module comprises an optical arrangement for adapting, for example, reducing, the numerical aperture between the input interface and the output interface, with a collimator and at least one convergence element, wherein, for example, a filter is arranged between the collimator and the convergence element.

At least one embodiment provides that a transfer fiber connects the input interface to the optical arrangement.

At least one embodiment provides that the electro-optical adapter module comprises a third optical connection from the input interface to the output interface for optical calibration signals.

At least one embodiment provides that the electro-optical adapter module comprises a calibration unit for generating the calibration signals.

At least one embodiment provides that the electro-optical adapter module comprises a data processing unit for realizing signal processing, measured value acquisition, data processing, and/or control of a probe.

The object is further achieved by a spectrometric system comprising an electro-optical adapter module as described above; and a spectrometric base module, comprising a housing; an input interface with a connector on the housing, wherein the input interface is designed to be connected to the output interface of the electro-optical adapter module; a spectrometer with at least one dispersive or diffractive element or an interferometer and a detector, wherein the spectrometer is optically connected to the input interface and the optical input signals are guided to the spectrometer; a laser for emitting the optical output signals, wherein the laser is optically connected to the input interface; and a data processing unit for controlling the laser and the detector.

At least one embodiment provides that a spectrometer fiber connects the input interface to the spectrometer, wherein the spectrometer fiber is designed such that the intensity distribution of the light guided through the spectrometer fiber and emerging from it defines a gap.

At least one embodiment provides that the spectrometer fiber comprises a plurality of optical fibers, wherein these are arranged essentially in a circle on the side of the input interface, and wherein the optical fibers are arranged linearly on the side of the spectrometer.

At least one embodiment provides that the spectrometric system comprises at least one probe with a cable, wherein the probe is connected via the cable to the input interface of the electro-optical adapter module.

At least one embodiment provides that the spectrometric system comprises at least a first probe with a first cable, wherein the first probe is connected to the first input interface of the electro-optical adapter module via the first cable; and at least a second probe with a second cable, wherein the second probe is connected to the second input interface of the electro-optical adapter module via the second cable.

At least one embodiment provides that the base unit comprises a calibration unit and be connected to the spectrometer.

### BRIEF DESCRIPTION OF THE DRAWINGS

This is explained in more detail with reference to the following figures.

FIGS. 1a and 1b schematically show the structure of a spectrometric system or a probe.

FIGS. 2a and 2b show the spectrometer fiber in various configurations.

FIGS. 3a, 3b, and 3c show the circuit diagram of a spectrometric system with one or four probes.

FIG. 4 shows a spectrometric system in an embodiment with a probe.

FIG. 5 shows a spectrometric system in an embodiment with a probe.

FIG. 6 shows a spectrometric system in an embodiment with four probes.

FIG. 7 shows a spectrometric system in an embodiment with four probes.

FIG. 8 shows the base module with optical adapter module.

FIGS. 9 a, 9b, and 9c show an optical adapter module in different views.

FIGS. 10a and 10b show an optical adapter module in one embodiment in different views.

### DETAILED DESCRIPTIONS

In the figures, the same features are labeled with the same reference signs. The spectrometric system 100 comprises an electro-optical adapter module 1 and a base module 20. It further comprises one or more probes 30, 31, 32, 33. The base module 20 comprises, inter alia, a laser 11 and a data processing unit 18.

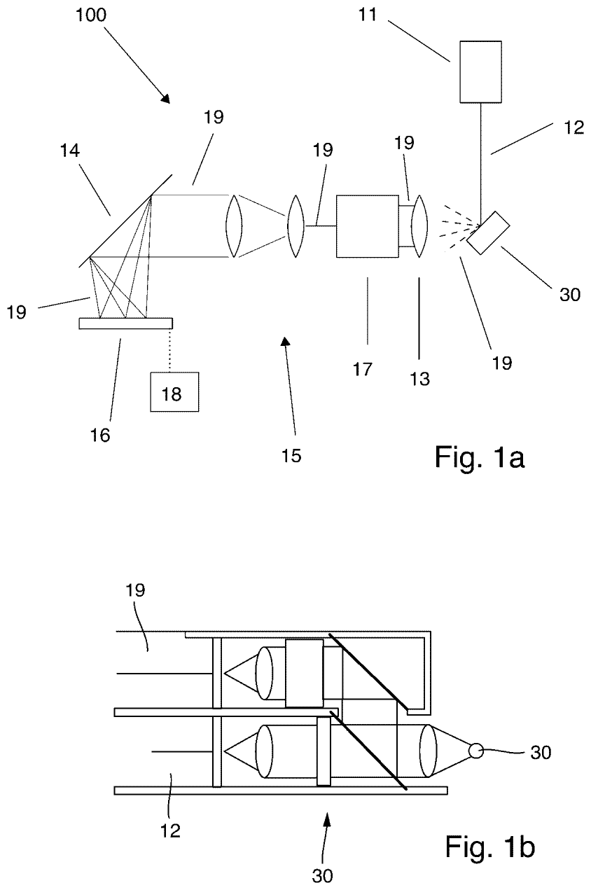

FIG. 1a illustrates a spectrometric system 100 by way of example. The system 100 includes a light source 11 configured and arranged to illuminate a probe 30 with light 12. The laser 11 thus sends “optical output signals”—for example, “excitation signals” or “control light”- to the probe 30. The probe 30 is in contact with the medium. In at least one embodiment, the probe 30 is not in contact with the medium, but, rather, sends the laser light into the medium or receives light from the medium. Depending upon the properties of the medium, the light arriving at the probe changes—for example, depending upon the concentration of a substance in the medium. The modified light, referred to in this document as “optical input signals,” “measuring signals,” or “measuring light,” is collected by a collector 13 and fed to a waveguide, the spectrometer fiber 17. In at least one embodiment, the collector may consist of one or more optical lenses.

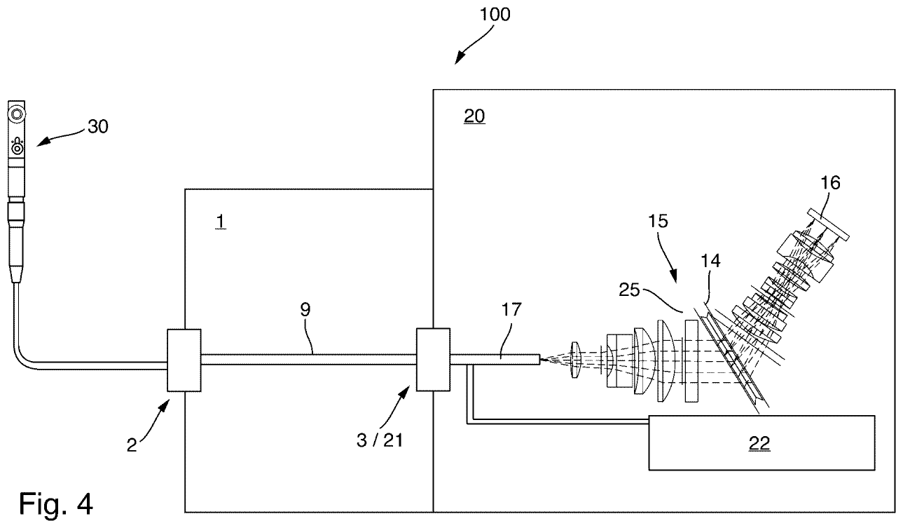

The spectrometer fiber 17 images the collected measuring light onto a slit-like outlet, which light is collected and collimated by a spectrometer 15 (see also FIGS. 4-7). A spectrometer 15 may, as shown in FIG. 1a, comprise two lenses—a first for diverging light emerging from the spectrometer fiber 17, and a second for collimating the diverging light and transporting the light to a dispersive or diffractive element 14. The dispersive or diffractive element 14 may, for example, be a grating, a prism, or the like. The dispersive or diffractive element 14 separates the measuring light 19 coming from the probe 30 into its spectral components, so that the light can be read out by the detector 16, which is usually designed as a two-dimensional array, such as a CCD array. The data processing unit 18 is connected to the laser 11 and the detector 16 (only the connection to the detector 16 is shown).

As an alternative to the embodiment with a diffractive or dispersive element 14, an interferometer can be used, with minor structural changes. The spectrometer comprises an arrangement of parabolic and plane mirrors in the beam path, which first expands the radiation from the light source (here, for example, a black body), couples it in between two parallel mirrors, couples it out, and concentrates it again. The interferometer comprises, for example, a beam splitter that forms two beams from the beam coming from the radiation source and recombines them, as well as a mirror drive that continuously changes the distance between the interferometer mirrors. If necessary, a HeNe laser is used as a reference radiation source for determining the location of the movable interferometer mirror(s).

In at least one embodiment, the spectrometer 15 may, for example, be of the Raman type, configured to perform Raman spectroscopic analysis.

FIG. 1b shows an embodiment of a probe 30. The probe may comprise one or more lenses, mirrors, possibly also dichroic mirrors, filters, and fibers. The light is guided in the probe and directed onto a sample. Input signals, such as Raman signals, are generated here. The input signals are captured and forwarded via the optics in the sample.

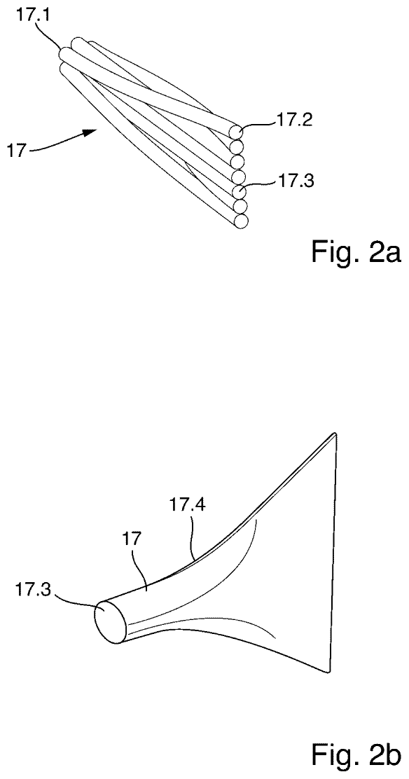

The spectrometer fiber 17 shall now be discussed. FIG. 2a shows an embodiment of the spectrometer fiber 17 for transporting light with an input end 17.1 and an output end 17.2. The spectrometer fiber 17 can be designed as a single fiber or a fiber bundle. The fiber comprises, as an example, seven optical light guides, also called filaments 17.3 here. The filaments 17.3 are arranged essentially in a circle at the input end 17.1. In this way, the light from the input interface 21 of the base module 20 (see below) can be effectively captured without major losses. The filaments 17.3 at the output end 17.2 are arranged such that the intensity distribution of the light transported and emitted by the fiber 17 defines a slit. Therefore, the output ends 17.2 of the filaments 17.3 are generally arranged linearly. In this way, the filaments 17.3 image the intensity distribution of the light at the input end 17.1, which is more or less cylindrically symmetrical to a substantially slit-like intensity distribution at the output end 17.2.

Each of the filaments 17 comprises a core made, for example, of a polymer, a glass, a crystal, or air, and a reflective coating covering the side surfaces of the core. In this way, the filaments 17.3 transport the light and keep it inside the fiber 17. The number of filaments 17.3 is not limited to seven. The filaments 17.3 can be held together and/or positioned by one or more frames. In at least one embodiment, as shown in FIG. 2b, the filaments 17.3 can be embedded in a shaping element 17.4, wherein the shaping element 17.4 supports and defines a course of the filaments 17.3 and the cross-section of the fiber 17 from the input end 17.1 to the output end 17.2.

In at least one embodiment, a slot-like structure is used after the output end 17.2.

As an alternative to the embodiment with linear filaments as described above, a classic slot can be used.

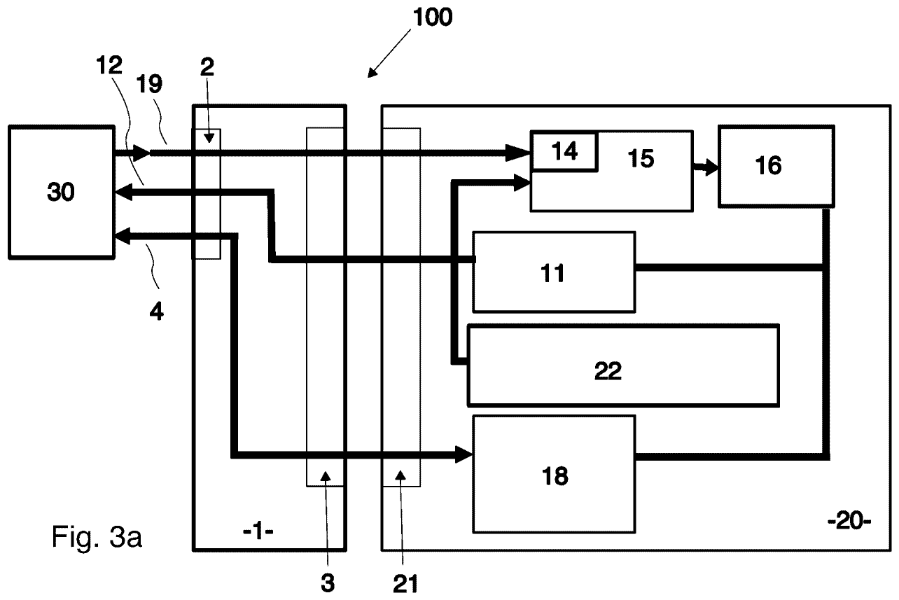

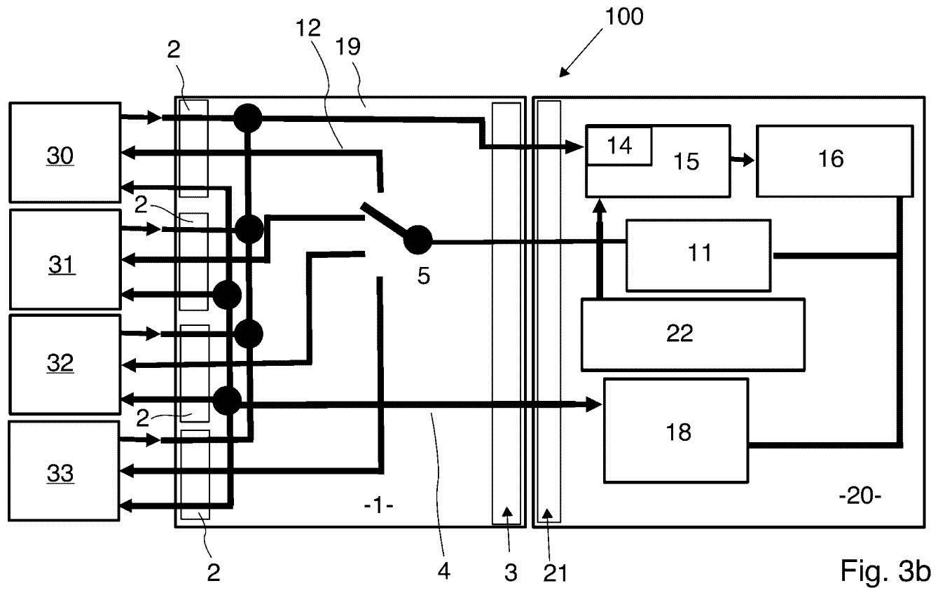

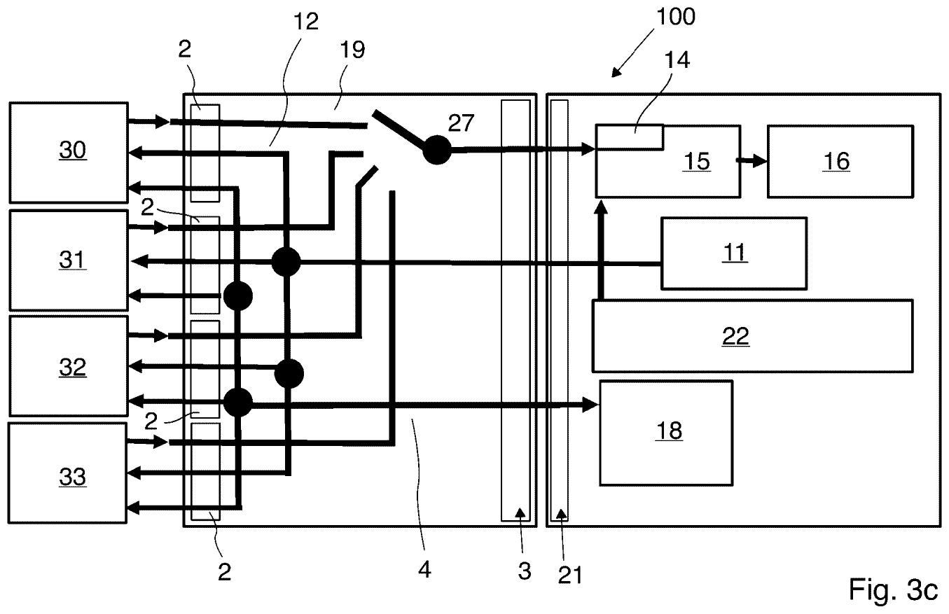

FIGS. 3a, 3b and 3c show the circuit diagram of the spectrometric system 100 with one or four probes. FIG. 3a shows the setup with one probe. FIGS. 3b and 3c show the setup with several probes.

As mentioned, the spectrometric system 100 comprises the electro-optical adapter module 1 and a spectrometric base module 20. The base module 20 comprises a housing with an input interface 21 with a connector, wherein the input interface 21 is designed to be connected to the output interface 3 of the optical adapter module 1. The input interface 21 and the output interface 3 or the respective connectors are designed to be complementary to one another. The base module 20 comprises the spectrometer 15 with at least one dispersive or diffractive element 14 (or interferometer; see above) and a detector 16, wherein the spectrometer 15 is optically connected to the input interface 21 and the optical input signals 19, i.e., measurement signals from the probe 30, are led to the spectrometer 15 and converted in the detector 16 into electrical signals, which in turn are further processed by the data processing unit 18. The base module 20 also includes the laser 11 for emitting the optical output signals 12, i.e., control light, wherein the laser 11 is optically connected to the input interface 21—for example, via optical fibers.

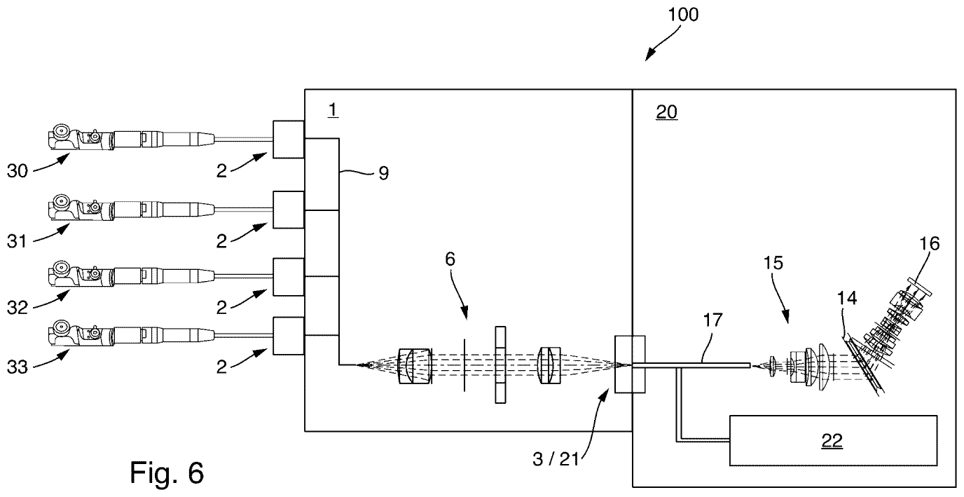

The electro-optical adapter module 1 comprises a housing with at least one input interface 2 with a connector on the housing, wherein the input interface 2 is designed to be connected to a probe 30 via a cable. The module 1 may, for example, comprise four input interfaces 2 for connecting up to four probes 30, 31, 32, 33. The adapter module 1 comprises the output interface 3 with connector, wherein the output interface 3 is designed to be connected to the spectrometric base module 20 (see above). The adapter module 1 comprises a unidirectional electrical connection from the probe 30 to the base module 20, but, for example, a bidirectional electrical connection 4 from the input interface(s) 2 to the output interface 3. The electrical signals are thus forwarded from the data processing unit 18 in the base module 20 to the probe 30, 31, 32, 33. The module 1 transmits optical input signals 19 from the input interface(s) 2 to the output interface 3 via a first optical connection, e.g., measuring signals from the probe 30, 31, 32, 33 to the base unit 20, ultimately to the detector 16. There are at least two possibilities for this in the case of a plurality of probes. Either fibers are combined as fiber bundles (see FIG. 6), or the input signals are expanded and collimated; then, they can be “superimposed” and then refocused. A multiplexer 27 or demultiplexer 5 can also be used for this purpose; see below.

The adapter module 1 transmits optical output signals 12, for example excitation signals (control light), from the laser 11 to the probe 30, 31, 32, 33 via a second optical connection from the output interface 3 to the input interface 2.

In comparison with the system with only one probe 30 (FIG. 3a), the system with four probes 30, 31, 32, 33 has an additional demultiplexer 5 or switch for the control light from the laser 11, i.e., the control light is distributed successively from one light source to the four probes; see FIG. 3b. The demultiplexer 5 is therefore a 1-to-n distributor, with n being the number of probes. In at least one embodiment, reception is not multiplexed, meaning that any ambient light or sunlight is also measured. In at least one embodiment, one laser is provided per probe. FIG. 3c shows a multiplexer 27, i.e., an n-to-1 converter of the input signals of the probes 30, 31, 32, 33. A demultiplexer 5 and a multiplexer 27 can also be used.

In one embodiment, the system 100 comprises both a demultiplexer 5 and a multiplexer 27. Each embodiment has advantages and disadvantages. In the embodiment shown in FIG. 3b, light from four probes reaches the detector simultaneously, even if no laser light is present at three of them (ambient light may also be measured). In the embodiment shown in FIG. 3b, this does not occur, but the laser light must be distributed.

In at least FIGS. 3a to 7, the base module 20 comprises a calibration unit 22, which sends calibration signals to the spectrometer 15. This module can also be located outside, in which case the calibration signals 23 are routed via the adapter module 1; see below. The adapter module 1 can also include the calibration unit. The calibration unit ensures that errors caused by temperature differences in the optical system, for example, are detected and corrected. The calibration unit is, for example, a broadband white light source (e.g., for intensity or y-axis calibration), possibly with a noble gas lamp (neon, argon, etc.) with defined peaks for x-axis calibration, a laser that shines on diamond, one or more NIST standards, or the like.

The connectors of the input interface(s) 2 and the output interface 3 of the adapter module 1 can be designed differently; examples are FC/PC connectors, LC connectors, or MTP connectors.

FIG. 4 shows an embodiment with a probe 30. The adapter module 1 has a transfer fiber 9 which connects the input interface(s) 2 of the adapter 1 to its output interface 3 and leads through the optical input signals 19 and optical output signals 12. The base module 20 is connected to the adapter 1 via the input interface 21 of said base module. The spectrometer fiber 17 is subsequently arranged on the input interface 21. To filter the control light 12 that is not to reach the detector directly, the base module 20 includes a filter 25.

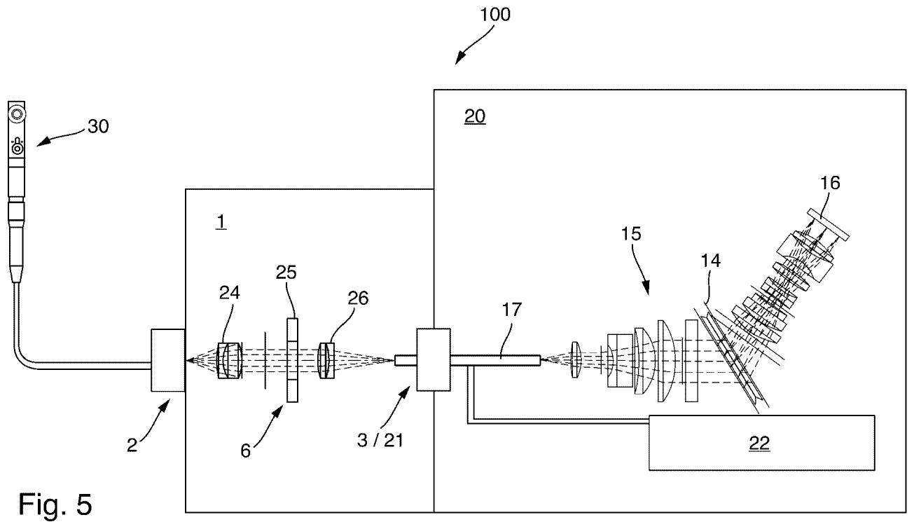

In FIG. 5, the electro-optical adapter 1 comprises an optical arrangement 6. The optical arrangement 6 serves to reduce the numerical aperture with one or more collimators 24 and at least one convergence element 26, wherein a filter system 25 with one or more filters is arranged between the collimator 24 and the convergence element 26. The filter system 25 is therefore relocated to the adapter 1, thus allowing a smaller filter to be used for the same purpose. The optical arrangement 6 is not shown in FIGS. 3a, 3b, and 3c, but can also be used there. In one embodiment, the filter system 25 is contained in the probe 30 and not in the base module 20 or adapter module 1.

As explained above, the essential point of the electro-optical adapter 1 is the connection of various probes to various light guides and connectors. Thus, the adapter 1 adapts the probe to the spectrometer 15. The components of the adapter 1 are designed accordingly; specifically, the collimator 24, the filter system 25, and the convergence element 26 are designed accordingly. In FIG. 4, for example, no numerical adjustment is provided.

FIG. 6 shows the arrangement from FIG. 4 with four probes 30, 31, 32, 33 and the optical arrangement 6, as well as the transfer fiber 9, which forwards the input and output signals 12, 19. In addition, an optical arrangement 6 can be used, as shown.

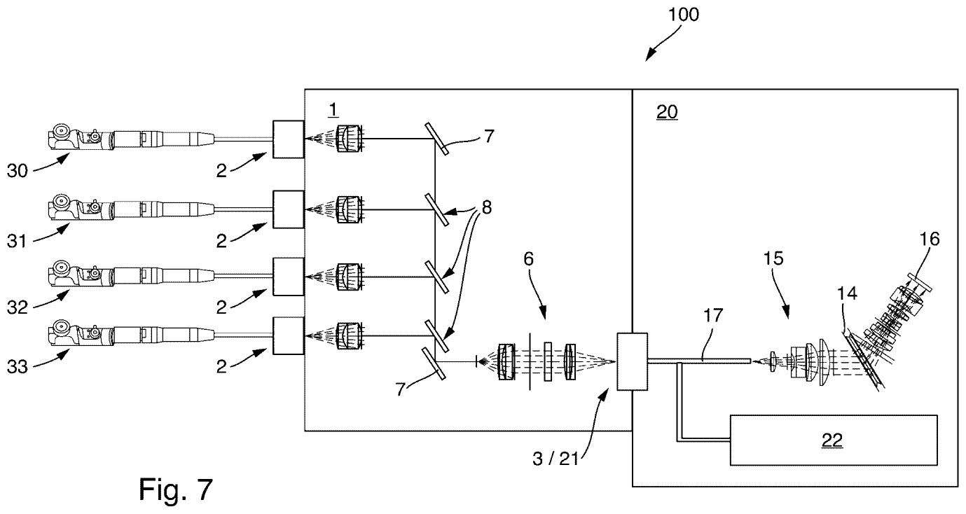

FIG. 7 shows a system 100 with four probes 30, 31, 32, 33. The input and output signals 12, 19 are forwarded via a mirror 7 and beam splitter 8. Other embodiments include optical switches and/or optical shunts.

The electrical signal lines 4 are not shown in FIGS. 4 to 7, but are required and led through as described above. In at least one embodiment, the adapter module 1 comprises additional electronics, e.g., a data processing unit, which implements further functions for signal processing, measured value acquisition, or probe control in the adapter module 1.

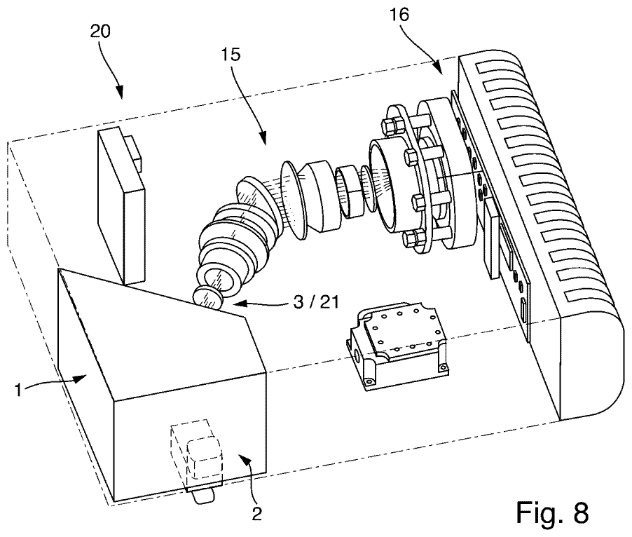

FIG. 8 shows the base module 20 with the electro-optical adapter module 1. The laser 11 is not shown. The adapter module 1 is connected via its output interface 3 to the input interface 21 of the base module 20. Also visible is the input interface 2 of the adapter module 1 (here, as a design with the possibility of connecting a probe).

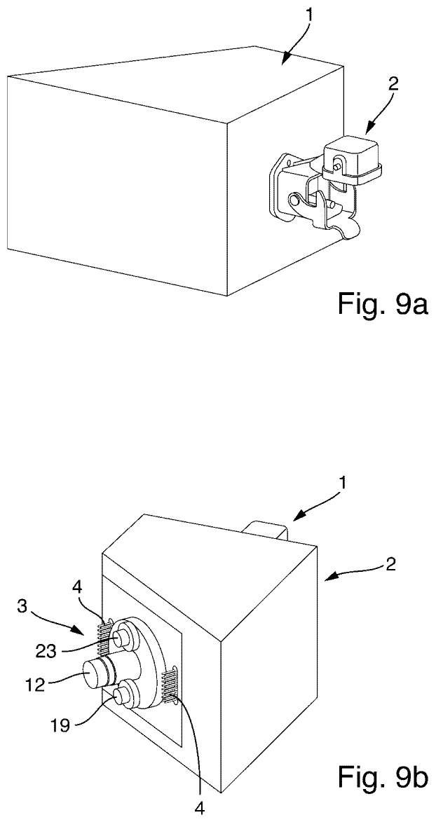

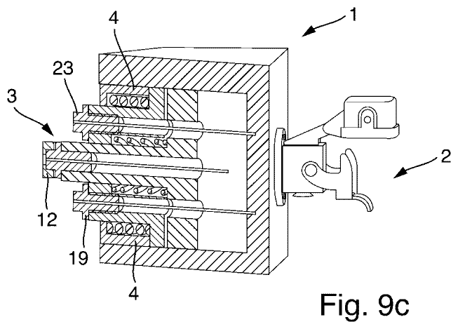

FIG. 9a shows the electro-optical adapter module 1 with an input interface 2 with a connector on the housing, via which it can be connected to a probe 30. FIG. 9b shows it in a rotated view. The output interface 3 is visible and is designed for a wide variety of connections. The first thing visible is the electrical connection 4. The embodiment shown has two electrical connections 4. The connection for the excitation signals 12 and measurement signals 19 is visible. In this embodiment, the adapter module 1 also includes a line for calibration signals 23. FIG. 9c shows the cross-section.

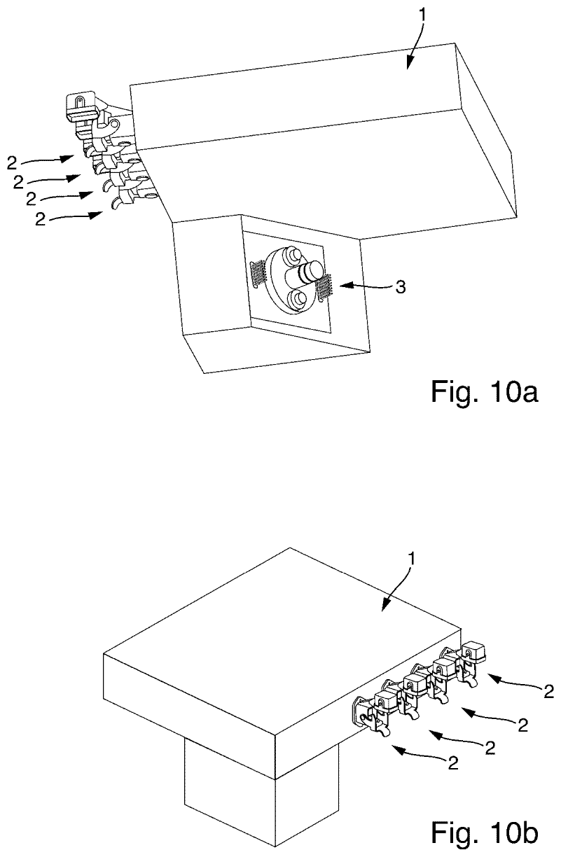

FIG. 10a shows the electro-optical adapter module 1 with four input interfaces 2 with connectors on the housing. This means that up to four probes can be operated. FIG. 10b shows it from the other side.

Claimed is:

1. An electro-optical adapter module comprises:
a housing;
at least one input interface including a connector, wherein the at least one input interface is disposed on the housing and is embodied to be connectable to a probe via a cable connection;
an output interface including a connector, wherein the output interface is disposed on the housing and is embodied to be connectable to a spectrometric base module via an electrical connection from the at least one input interface to the output interface;
a first optical connection from the at least one input interface to the output interface for transmitting optical input signals; and
a second optical connection from the output interface to the at least one input interface for transmitting optical output signals.

2. The electro-optical adapter module of claim 1, wherein the output interface is connectable to a spectrometric base module via a bidirectional electrical connection.

3. The electro-optical adapter module of claim 1, wherein the optical input signals include measurement signals.

4. The electro-optical adapter module of claim 1, wherein the optical output signals include excitation signals.

5. The electro-optical adapter module according to claim 1,
wherein the connector of the at least one input interface and the connector of the output interface are different connector types.

6. The electro-optical adapter module according to claim 1,
wherein a transfer fiber connects the at least one input interface to the output interface, and the transfer fiber transmits the optical input signals and the optical output signals.

7. An electro-optical adapter module according to claim 1, wherein the at least one input interface includes:
a first input interface including a connector, wherein the first input interface is disposed on the housing and embodied to be connectable to a first probe via a first cable; and
at least one second input interface including a connector, wherein the second input interface is disposed on the housing and embodied to be connectable to a second probe via a second cable, wherein
the first optical connection transmits optical input signals from the first input interface and the at least one second input interface to the output interface,
the electro-optical adapter module further comprising an optical selection circuit interposed in the second optical connection, wherein the optical selection circuit distributes optical output signals from the output interface to the input interface.

8. The electro-optical adapter module according to claim 1, further comprising an optical arrangement interposed between the at least one input interface and the output interface, wherein the optical arrangement adapts a numerical aperture using a collimator and at least one convergence element, wherein a filter is arranged between the collimator and the convergence element.

9. The electro-optical adapter module according to claim 1, further comprising a third optical connection to connect the at least one input interface and the output interface for transmitting optical calibration signals.

10. A spectrometric system, comprising:
an electro-optical adapter module according to claim 1; and
a spectrometric base module comprising:
a base housing;
a base input interface including a base connector, wherein the base input interface is disposed on the base housing and is connectable to the output interface of the electro-optical adapter module;
a spectrometer including a detector and at least one dispersive element, at least one diffractive element, or an interferometer, wherein the spectrometer is optically connected to the base input interface and the optical input signals are passed to the spectrometer;
a laser for emitting the optical output signals, wherein the laser is optically connected to the base input interface; and
a data processor configured to control the laser and the detector.

11. The electro-optical adapter module according to claim 7, wherein the first optical connection comprises mirrors, optical switches, optical shunts, and/or beam splitters.

12. The electro-optical adapter module of claim 7, wherein the optical selection circuit includes an optical demultiplexer or an optical switch.

13. The electro-optical adapter module of claim 8, wherein the optical arrangement reduces the numerical aperture.

14. The electro-optical adapter module according to claim 8, wherein a transfer fiber connects the at least one input interface to the optical arrangement.

15. The electro-optical adapter module according to claim 9, further comprising a calibration unit configured to generate optical calibration signals.

16. A spectrometric system according to claim 10, wherein a spectrometer fiber connects the base input interface to the spectrometer, wherein the spectrometer fiber is embodied such that an intensity distribution of light guided through and emitted from the spectrometer fiber defines a slit.

17. A spectrometric system according to claim 10, further comprising:
a first probe including a first cable, wherein the first probe is connected via the first cable to the at least one input interface of the electro-optical adapter module; and
at least one second probe including a second cable, wherein the at least one second probe is connected to the second input interface of the electro-optical adapter module via the second cable.

18. A spectrometric system according to claim 10, further comprising:
at least one probe including a cable, wherein the at least one probe is connected via the cable to the at least one input interface of the electro-optical adapter module.

19. A spectrometric system according to claim 10, wherein the base module further comprises a calibrator and the base module is connected to the spectrometer.

20. The electro-optical adapter module according to claim 15, further comprising a data processor configured for signal processing, measured value acquisition, data processing, and/or control of a probe.

21. A spectrometric system according to claim 16, wherein the spectrometer fiber comprises a plurality of optical fibers, wherein the optical fibers are arranged essentially in a circle at the connection of the base input interface and wherein the optical fibers are arranged linearly at the connection of the spectrometer.
